(19) United States
(12) Patent Application Publication
(10) Pub. No.: US 2013/0133490 A1
(43) Pub. Date: May 30, 2013

(54) METHOD FOR CLASSIFYING THE QUALITY OF FOOD SLICES OF A STICK OF FOOD

(71) Applicants: Jorg Schmeiser, Wiggensbach (DE); Silvio Quaglia, Milano (IT); Rainer Maidel, Durach (DE); Wilfried Maier, Probstried (DE)

(72) Inventors: Jorg Schmeiser, Wiggensbach (DE); Silvio Quaglia, Milano (IT); Rainer Maidel, Durach (DE); Wilfried Maier, Probstried (DE)

(73) Assignee: CFS BUHL GMBH, KEMPTEN (DE)

(21) Appl. No.: 13/518,602

(22) PCT Filed: Nov. 24, 2010
(86) PCT No.: PCT/EP10/07104

§ 371 Date: Feb. 18, 2013

(30) Foreign Application Priority Data
Dec. 23, 2009 (DE) 10 2009 060 536.3
Apr. 6, 2010 (EP) PCT/EP2010/002149
Apr. 30, 2010 (DE) 10 2010 019 096.9

(51) Int. Cl. B26D 5/00; B26D 3/28

(52) U.S. Cl. CPC B26D 5/007; B26D 3/28
USPC 83/39; 83/13

(57) ABSTRACT

The present invention relates to a method for producing food portions by means of a slicing device, in particular a slicer, wherein said food portions comprise at least one food slice and are cut from a stick of food using the slicing device, wherein the stick of food is irradiated, preferably by means of x-rays, before the particular food portion is sliced and the data measured in the process are used to control the slicing device and/or a device arranged downstream of the slicing device.

The present invention relates to a method for creating food portions using a slicing device, in particular a slicer, said food portions consisting of at least one food slice and being sliced off a slab of food by means of the slicing device, wherein the food slab is irradiated, preferably by way of x-rays before being sliced and the data determined at this time is used to control the slicing device and/or a device arranged upstream of said slicing device.

A method of this type is described, for example, in DE 10 2005 010 183. Food products are nowadays often presented in portions which consist of several food slices. The food slices are sliced, for example, from a food slab and are then or at the same time configured to form portions. As a rule, the quality of the food slab is not consistent over its entire length. For example, hard cheese often has too few a number and/or too small a size of holes in the region of the start and of the end and consequently does not meet the desired quality demands. The same also applies to meat products which have too little a proportion of muscle and/or too small a cross section of muscle. Such food slices either have to be rejected and/or processed further or presented to the market as reduced quality food slices.

Consequently, it has been the object of the present invention to provide a method by way of which it is possible to classify the quality of food slices which are sliced off a food slab.

The object is achieved with a method for creating food portions using a slicing device, in particular a slicer, said food portions consisting of at least one food slice and being sliced off a slab of food by means of the slicing device, wherein by way of a measuring means, preferably an irradiation scanner, in a particularly preferred manner an x-ray scanner, data on the inner and/or outer structure of the food slab is acquired from said food slab before the respective food portion is sliced, wherein
the data determined is acquired in a data matrix,
said matrix is evaluated and
the evaluation is used to control the slicing operation and/or to classify the sliced food slices.

The statements made for said method as claimed in the invention apply to the other methods as claimed in the invention in an equal measure and vice versa.

The present invention relates to a method where a food slab is sliced into a plurality of food slices and at least one, preferably a certain number of food slices, are assembled to form a food portion. The slicing of the food slab is effected using a slicing machine, a so-called slicer.

A food slab in terms of the invention is preferably a sausage, cheese or ham slab. Said food slabs often have a substantially constant cross section. As a rule, the food slabs, like a sausage, are oblong, i.e. their cross section is considerably smaller than their length. As a rule, the food slices are separated off at a right angle with respect to the longitudinal axis. The food slab can, however, also be a natural ham. The food slab can also be assembled from a plurality of part pieces, as is the case, for example with pressed ham.

Before the slicing process, the inner and/or outer structure of the food slab is determined using a measuring means. For example, the measuring means can be an irradiation scanner, in particular an x-ray scanner. The determining of the inner and/or outer structure of the food slab is described below in an exemplary manner by way of an x-ray scanner, other measuring means also being suitable in a manner as claimed in the invention. Such an x-ray scanner has a source of radiation and a sensor, for example a photosensitive sensor, as a receiver which is located in each case on opposite sides of the periphery of the food slab. Said sensor is, for example, a line camera. The radiation source transmits rays which enter on one side of the periphery of the food slab, penetrate the food slab over its entire width and are received by the sensor on the opposite side. Said sensor measures the local intensity of the received rays, which are weakened during the irradiating of the food slab, the weakening depending on the local character of the food slab, for example on its density. The irradiation is effected at least over the entire width of the food slab, several discrete measured values being determined as a function of the width. The irradiation scanner is preferably provided in a fixed manner and the food slab is preferably conveyed through the irradiation scanner along its longitudinal axis. This means that discrete measured values are determined over the entire length of the food slab. Several measured values per measurement as a function of the width and a plurality of measurements in the longitudinal direction produce a data matrix of the respective food slab. During the measuring, the food slab is located, for example, on a conveyor belt which is arranged between the radiation source and the sensor. The, expert understands that the scanner can also be moved in relation to the food slab. The statements made above and below apply analogously to this case. The inner and the outer structure of the food slab can be acquired using the measuring means.

The data which is acquired by the measuring means is deposited as claimed in the invention into a data matrix. The data matrix is preferably a two-dimensional representation of the spatial data of the food slab; i.e. the data is in one dimension, preferably the height of the product, a cumulative value, which is often already conditioned by the measuring method. The height of the product here is its extent in the vertical. However, a plurality of data is discretely determined in each case along the entire width and along the entire length of the food slab by the measuring means such that a data matrix is produced from a x b data dots. The number of necessary data dots depends on the desired accuracy. In a preferred embodiment, the data matrix is a three-dimensional representation of the spatial data of the food slab, i.e. the measured data is present along all directions in space as discrete measured data.

The data dots are preferably gray scale values such that the entire data matrix produces a halftone picture of the food slab.

As a result of the distribution of the gray scale values in the data matrix, an evaluating means detects local changes in the structure, for example the meat structure. For example, a change in the gray scale value distribution also indicates a local change in the structure, for example the boundary layer between muscle and fat tissue. An unexpectedly higher or lower gray scale value indicates a foreign body, for example a piece of metal, a splinter of bone and/or a bruise or an inclusion of air. In addition, the distribution of the gray scale values allows conclusions to be made as to the width of the product.

The halftone picture is preferably processed using image recognition software. As a result of the halftone picture, the image recognition software detects certain structures, for example muscle structures, holes in the cheese, boundary layers between parts which make up the food slab, foreign bodies, fat layers and/or variable salt contents.

These recognized structures are stored and are later used to control the operation of slicing the food slab or the subsequent classifying of the food slices. By way of this information, it is then possible to establish how the food slab is to be sliced, how large the residual piece at the start/end of the food slab has to be and/or the food slices are classified by way of the information obtained.

The analysis is preferably effected by comparing the gray scale values to reference data, as a result of which the evaluating means, for example the image recognition software, then detects which local structure the food has and/or whether it is a foreign body. This reference data can be, for example, another section of said food slab, historical data of food slabs and/or filed reference values, for example gray scale values which correlate with a certain structure, for example fat or muscle tissue.

The irradiation of the food slab is preferably effected slice by slice, the slices preferably being arranged at a right angle with respect to the longitudinal centre axis of the food slab and/or being provided parallel to the guiding of the cutting blade. The desired thickness of such a slice, which is referred to as a “scan slice”, depends on the desired measuring accuracy. The thickness of the scan slice, however, is preferably smaller than the food slice to be separated from the food slab. The irradiation scanner has a means which assigns a coordinate x within the food slab to each scan slice such that all the measured values are present as a function of the longitudinal axis and can be deposited in a corresponding manner in the data matrix. Per scan slice, a plurality of measured values, which are also deposited in the matrix, are also determined over the width of the scan slice. Thus the measurement results, which are transferred to the slicing device as a function of the longitudinal axis, can be used when slicing the food slab, where the food slab is conveyed parallel to its longitudinal axis in the direction of a cutting blade, which severs food slices from the food slab from the front end thereof and at a right angle with respect to the longitudinal axis of the food slab. As an evaluating device knows which part, with reference to the longitudinal axis, of the food slab has just been sliced, classifying into different grades and/or rejecting the respective food slice can be effected after the slicing process.

Classifying in terms of this invention means that the sliced food slices and/or sections of the food slab are divided into different grades and/or are completely rejected.

Classifying means, for example, ranking the food slices into a corresponding grade by way of the development and/or the cross sectional area of at least one muscle.

As claimed in a preferred object of the present invention, the food slab consists of several, preferably two, part pieces which adjoin along a boundary surface and there are preferably connected together in a positively bonded manner, the data having information on the development of the boundary surface and this information being used to slice the food slab and/or to classify the food slices into grades.

The boundary surface extends, preferably at least in sections, along the longitudinal axis of the food slab.

Classifying is effected in the present case by way of the development of the boundary surface within the respective food slice and/or the quality of the boundary layer for example with reference to form, width and/or color. The grade is preferably all the higher, the further the boundary surface is displaced into the edge region of the respective food slice or if there is absolutely no boundary surface present and/or if the boundary surface is as little visible as possible.

As claimed in a preferred object of the present invention, the evaluatable length of the food slab is determined from the data determined by the irradiation scanner.

The evaluatable length can correspond to the entire real length of the food slab. However, the evaluatable length is often smaller than the actual length because the food slabs often taper in their start and/or end region and consequently can often only be separated from the food slab to form food slices that are too small. In addition, the start and end regions can have further quality defects which make them unsuitable as “good portions”. For example, the start or end piece of cheese can have too few holes. When slicing food slabs, grabs are often used which dig into the end of the food slab. This section of the food slab, which, for example, can be up to 2 cm, is then also unsuitable for food slices in a food portion and consequently cannot be included in the evaluatable length. The data determined by the irradiation scanner and/or further data on the slicing machine, for example the grab, preferably allows the evaluatable length to be determined in an automatic manner.

In the case of said preferred method, an evaluating unit, for example a computer, evaluates the scan data, the weight, the length and/or the evaluatable length of the food slab preferably such that as many preferably complete portions are able to be removed from the food slab. Particularly preferred in this case, the data is evaluated before the slicing of the respective food slab such that as many food portions as possible are removed from a food slab, that the “give away” according to the Packaging Directive is minimized for all portions such that as many portions as possible are created from one food slab and/or that the “give away” is distributed so evenly in the portions that they are all reliably above the minimum required weight.

As claimed in a further or preferred object of the present invention, by way of the data determined the evaluatable length of the food slab is sliced into n portions which in each case have at least the required minimum weight, the last portion of the one food slab being supplemented by food slices from the next food slab and the slicing device or another control device knows by way of the scan data determined which proportion by weight and/or how many slices are missing from said portion and controls the slicing operation accordingly such that said portion is supplemented by slices from the next food slab. The incomplete portion must not be weighed for this.

In one preferred embodiment, the slicing machine is controlled by way of the data determined by the irradiation scanner such that each food slice of a portion has a minimum weight. The thickness and consequently the weight of the food slice can be adjusted by means of the speed at which the food slab is conveyed in the direction of a cutting blade in relation to the speed of the cutting blade.

In a preferred embodiment, the slicing machine is controlled by way of the data determined by the irradiation scanner such that each portion has a minimum number or a maximum number of food slices. The length to be separated off for the respective portion is calculated and then divided into the desired number of food slices which preferably lies between a minimum and a maximum value.

In a preferred embodiment, the slicing machine is controlled by way of the data determined by the irradiation scanner such that each food slice has a minimum or maximum thickness. The thickness of the slice can be adjusted by means of the speed at which the food slab is conveyed in the direction of a cutting blade.

The local height of the food slab is preferably determined by way of the data matrix. The local height of the food slab can play a role in particular when the products are stacked to form a portion.

The data matrix preferably has local temperature data and/or local data on the salt content. This data can be relevant for controlling the slicing operation and/or for the classifying process.

As claimed in a preferred design or a design as claimed in the invention of the present invention, the data is used to control the cutting speed and/or to control the position of the cutting blade. As a rule, the cutting speed is proportional to the speed at which the blade rotates. Depending on the local consistency of the food slab, it can be sliced at a higher or lower speed. As this local consistency is known through the determined data of the food slab, the cutting speed can be controlled in a corresponding manner. A food slab is then sliced, for example, at various cutting speeds.

In addition, as claimed in the invention or in a preferred manner, the axis of rotation of the cutting blade head and/or of the cutting blade can be modified in dependence on the determined data. This means that the location at which the blade contacts the food slab and the ratio between pulling and pressing can be modified during cutting.

According to a further object of the present invention, which is as claimed in the invention or preferred, the data is used to control portion forming parameters. In particular, the stacking table onto which the sliced food slices fall is controlled as a result of the determined data. In particular, preferably its height, its alignment in the direction of fall and transversely with respect to the direction of fall of the food slice, its inclination about at least one, preferably two horizontal axes of rotation which are at a right angle with respect to one another and/or the speed at which the finished portion is conveyed away.

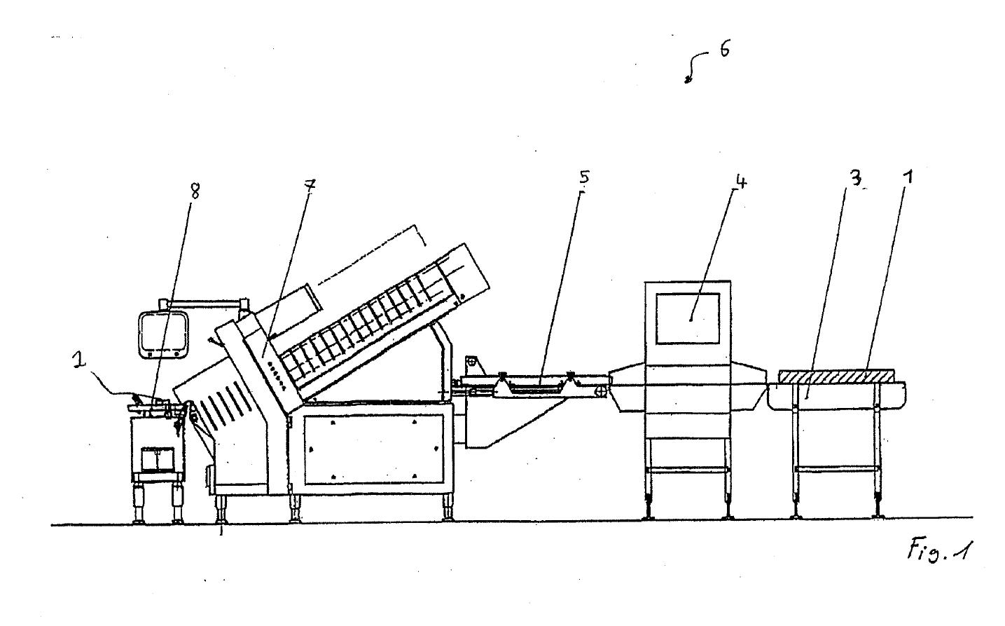

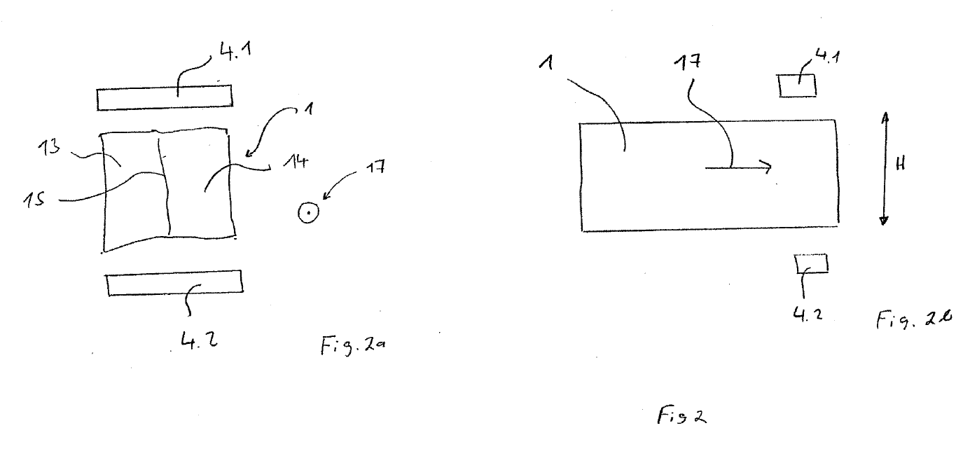

The invention is explained below by way of FIGS. 1-7. These explanations are purely exemplary and do not restrict the general objects of invention. The explanations apply equally to all objects of the present invention.

FIG. 1 shows a slicing line.

FIGS. 2a and b show a measuring means, in this case an x-ray scanner.

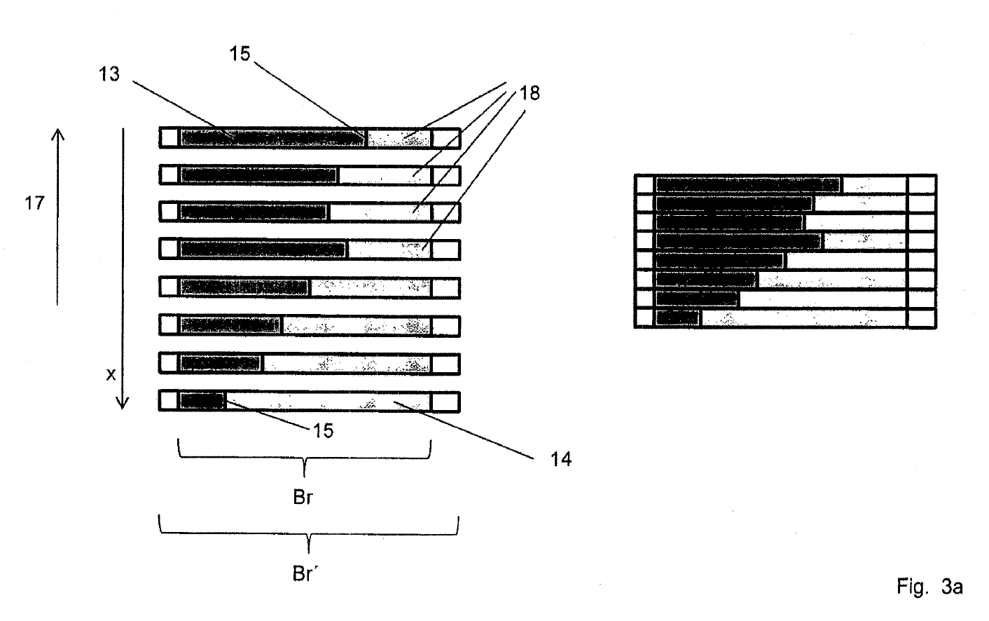

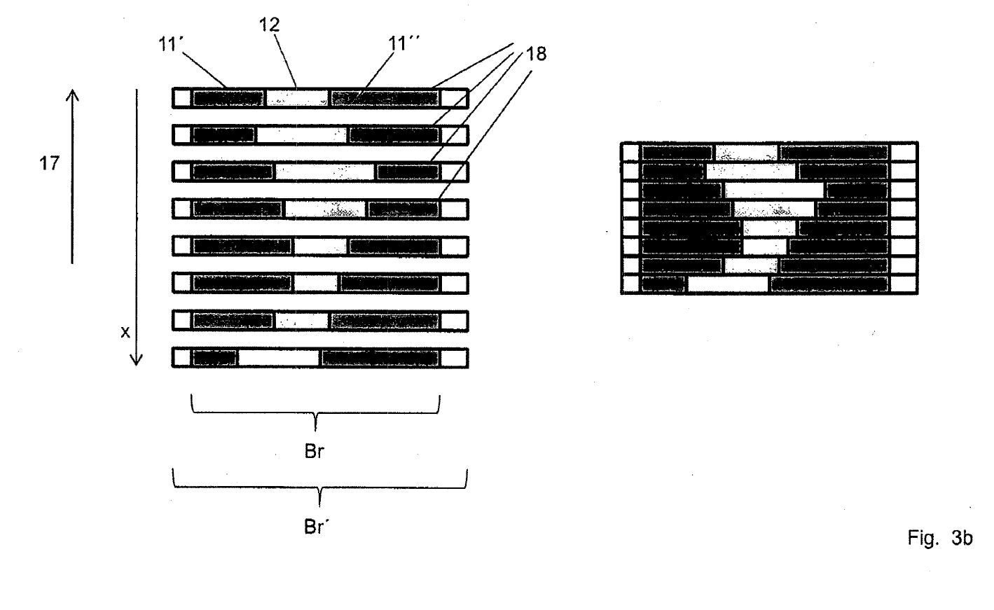

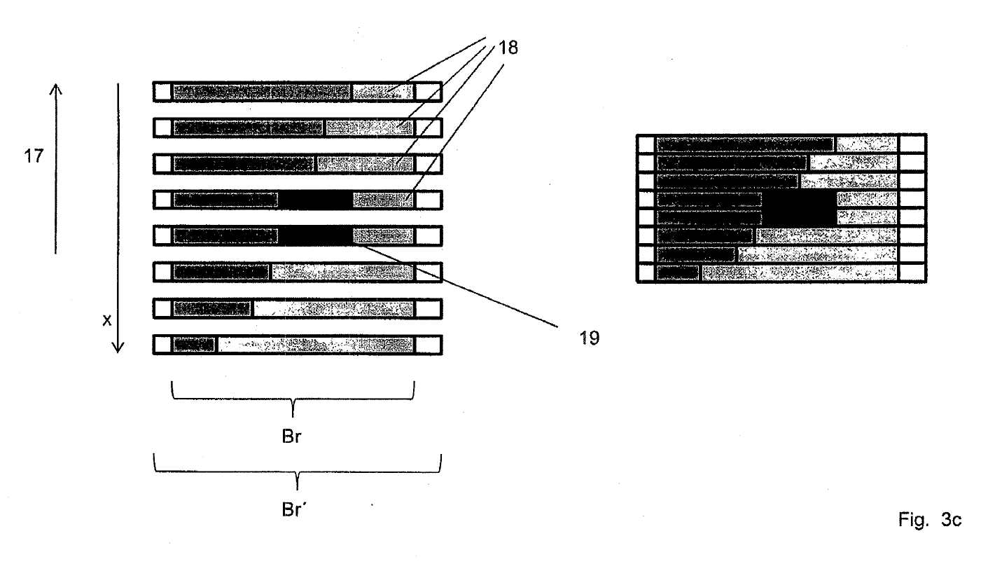

FIGS. 3a-c show the measured data as a function of the width and of the length of the food slab.

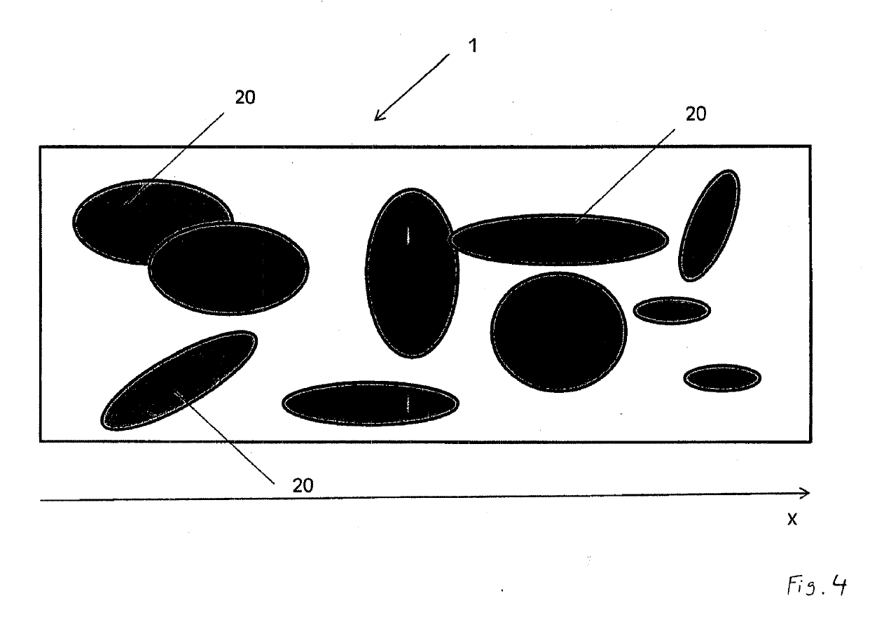

FIG. 4 shows further measured data of a food slab.

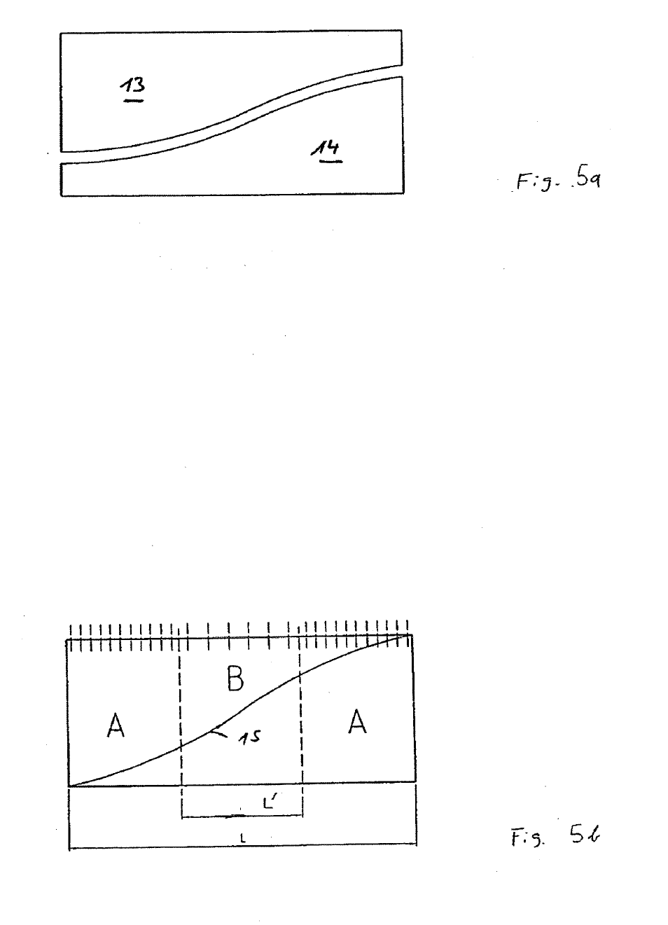

FIGS. 5a and b show an embodiment of the method as claimed in the invention.

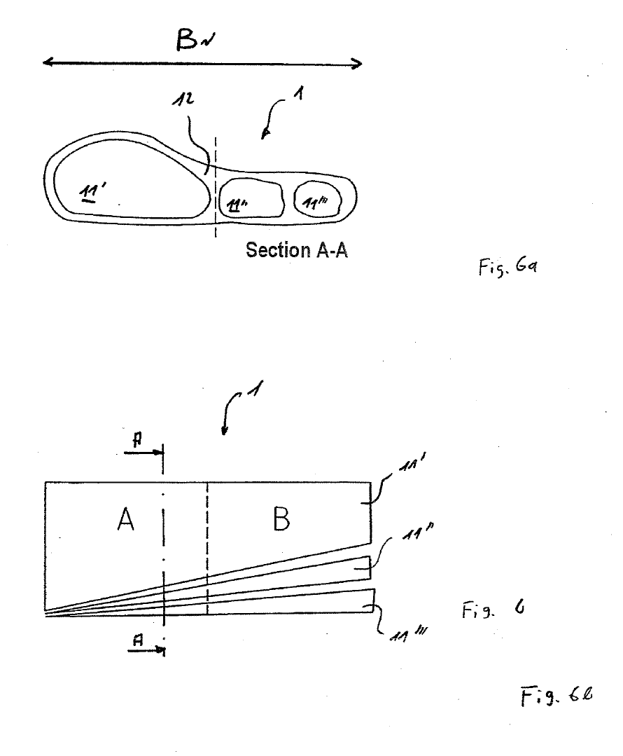

FIGS. 6a and b show another embodiment of the method as claimed in the invention.

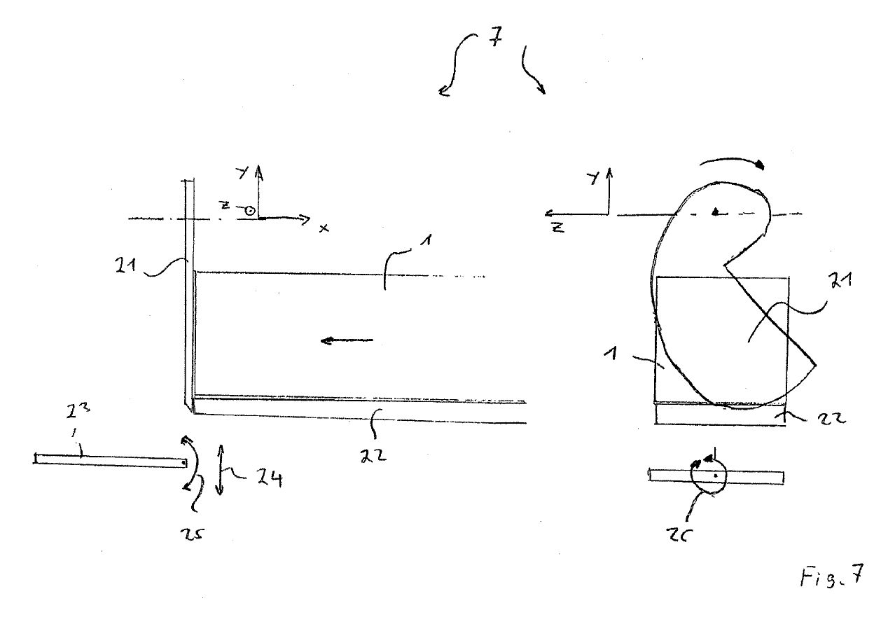

FIG. 7 shows a slicer.

FIG. 1 shows a slicing line on which food slabs are sliced into food slices and at the same time as precisely weighted portions as possible are created. A food slab 1 is conveyed by way of an inlet belt through a measuring means, in this case an irradiation scanner 4, preferably an x-ray scanner. The product is scanned slice by slice in the scanner. Where applicable, the food slab 1 is first of all weighed using scales 3. Once the food slab has been scanned, it is loaded into the slicer 7 by means of the inlet conveyor belt 5. Said inlet belt can also include a buffer in which already scanned food slabs wait to be sliced. The data determined by the irradiation scanner is either transmitted directly to the slicing device or to another control unit/CPU, where it is processed further where required. The slicing operation in the slicing device and/or the stacking operation of the sliced food slices are then controlled according to the method as claimed in the invention by way of the data determined during scanning. In addition, food slices are classified, where applicable, into various product groups. After the slicing process, the respective food portions can be transferred to a weighing device in order to check whether the desired required weight has been maintained. Said data can be used to calibrate the data evaluation of the irradiation scanner. The expert knows that the scanner can also be arranged within the slicing device 7, for example in the region of the product inlet. Several food slabs can be sliced at the same time in the slicing device.

FIG. 2 shows the measuring, in this case scanning of a food slab 1 using an irradiation scanner, namely an x-ray scanner. In the present case, the food slab 1 is assembled from two part pieces 13, 14. FIG. 2a shows a front view and FIG. 2b a tilted side view of the food slab 1 or of the irradiation scanner 4. During scanning, the food slab is arranged such that the boundary surface 15 is situated substantially parallel to the direction of irradiation of the irradiation scanner, i.e. the boundary surface 15 is provided substantially parallel to the rays which are transmitted by a transmitter 4.1 or received by a receiver 4.2. The conveying direction of the food slab is shown by the arrow 17, it being possible to move the food slab past the irradiation scanner in a continuous or intermittent manner. The receiver 4.2 is preferably a line receiver, for example a line camera such that using the scanning method data can be generated in the form of scan slices. In the present case, the data obtained provides an integral on the height H of the food slab such that a two-dimensional data matrix is produced. In the case of the present measuring method, local gray scale values of the food slab are determined and these allow, for example, a conclusion on its inner and outer structure. The expert knows that the measured values generated can also be other values which enable a conclusion on the inner and outer structure of the food slab.

FIGS. 3a-c show in an exemplary manner the data determined per scan slice 18 by an x-ray scanner according to FIG. 2. The width Br′ of the scanner, and consequently of each scan slice 18, is larger in this case than the width Br of the food slab such that each scan slice also supplies information on the actual local width Br of the food slab and consequently of the outer structure of the food slab. It is important to the quality classification for the gray scale value distribution of each scan slice to be analysed over its entire width and for several discrete values to be present as a function of the width. In addition, the values must also be present as a function of the longitudinal coordinate x. The entire length of the food slab is analyzed in this manner. The data determined is acquired in a data matrix such that a two-dimensional data field, for example a halftone picture of a food slab is produced. A two-dimensional halftone picture of a food slab of this type can be seen in each case in the right-hand part of the FIG. 3. It can be seen that each scan slice has a darker region in which relatively fewer rays have been absorbed and a brighter region in which relatively more rays were absorbed. This overall image is then analyzed, for example using image recognition software. In this case, it is possible to determine, for example, how the holes in a cheese extend over the entire depth, i.e. in the direction of irradiation, as a function of the x-axis. In addition, it can be ascertained by means of the overall image analysis how a muscle or a boundary layer extends between two pieced-together meat pieces as a function of the longitudinal axis. It is possible to determine the local volume of holes in the cheese or of a muscle. The halftone picture is preferably analyzed by way of reference data such that the evaluation unit knows what type of meat structure it is or whether the respective gray scale value and/or its development indicates a boundary layer or a foreign body. As a result of the analysis of the overall image of the food slab it is determined how the food slab is to be sliced and/or how the resulting food slices are to be classified.

In the example according to FIG. 3a, the food slab consists of two part pieces 13, 14. The evaluation device is able to detect the development of the boundary layer 15 through the distribution of the gray scale values. However, it is also possible for the two part pieces 13, 14 to have an almost identical structure. In this case, only the boundary layer has another gray shade which is detected by the image evaluation.

The example according to FIG. 3b shows the scan slices of a food slab which has muscle 11′, 11″ and a fat layer 12. The respective meat structure 11′, 11″, 12 has been detected by way of the evaluation device by way of reference data. The development of the respective structures 11′, 11″, 12 within the food slab become clear by means of the overall image. This information can be used during the slicing process or to classify the food slices.

FIG. 3c substantially shows the example according to FIG. 3a, only a foreign body 19 is present in the present case. The image recognition detects the foreign body preferably by its grey level being unexpectedly high or low.

FIG. 4 shows a schematic representation of the evaluation of the data matrix of a food slab. As a result of the image recognition and/or reference data, the image recognition software detects the position of the holes 20 in a cheese slab 1. The position of the holes is stored at least as a function of the x-axis, i.e. of the slicing direction, such that in the end data is present as to which food slice has which proportion of holes. From the representation according to FIG. 4 it can be seen that in the front and rear edge region of the food slab 1 there are no holes present such that these regions cannot be used as good portions and have to be rejected.

FIG. 5 shows a food slab 1 which is assembled from two part pieces 13, 14. For example this is pressed ham. In reality, there is no spacing between the part pieces or it is only present in a slight and/or local manner. Said food slab 1 is also irradiated by means of an irradiation scanner, the development of the boundary surface 15 between the two part pieces 13 and 14 being determined in dependence on the longitudinal axis and/or its quality with reference to form and color during said operation and being stored as a function of the longitudinal axis of the food slab. As can be seen in particular in FIG. 4, this information on the development of the boundary surface 15 is used during the slicing of the food slab and/or to classify the slices obtained. It can be recognized that the food slab has two regions with grade A in which the boundary surface 15 is situated in the edge region of the respective food slice. In the present example, these regions with grade A are sliced such that each food portion has five food slices which are 1 mm thick and are arranged in a shingled manner with respect to each other, a paper leaf, which is to prevent the two slices adhering together, being inserted between the respective slices. The central region with grade B, in contrast, is sliced such that each portion has 10 slices which are 2 mm thick and are stacked one on top of the other, no paper leaf being provided between the slices. The expert understands that the slicing or classifying can also be effected according to another mode.

FIG. 6 shows a food slab. In the present case this is, for example, a natural ham which in this case has three muscles 11′ to 11′″ which are surrounded by a fat layer 12. As can be seen in particular from FIG. 2b, the cross section of the respective muscle alters with the longitudinal axis of the food slab. This means that two different grades are produced within the food slab, namely a grade A in which the muscle 11′ makes up the essential part of the cross section of the food slab and a grade B in which the muscle 11′ becomes smaller and smaller and the fat proportion of the respective food slice becomes greater and greater. Even the width Br of the respective food slice can decide its grade. If the respective food slice falls below a certain width Br, it is unsuitable for grade A. The food slab is irradiated along its longitudinal axis, in this case at a right angle with respect to the paper plane, and over the entire width Br by an irradiation scanner, in this case a x-ray scanner. The structure of the food slab, in this case the development of the respective muscles and/or the fat content is determined during this irradiation operation and this data is stored as a function of the longitudinal axis x. The slicing and/or classifying is then effected by way of said data such that part of the resulting portions are grade A and part are grade B.

FIG. 7 shows two views of a schematic representation of a slicer 7. A food slab 1 lies on a support 22 and is conveyed as represented by the arrow in the direction of a rotatingly driven cutting blade 21, which separates food slices off from the front end of said food slab, said food slices falling onto a stacking unit, in this case a stacking table 23, and there being combined to form one portion of, for example, ten food slices. As soon as one portion is completed, it is conveyed away from the stacking table 23 and a new portion can be sliced. The blade 21, as shown by the coordinate system, is adjustable in the y-direction and the z-direction in order to be able to influence the location where the blade is to enter the food slab or in order to be able to influence the ratio between pulling and pressing during the cutting of a food slice. The stacking table 23, onto which the sliced food slices fall, is preferably provided so as to be pivotable in its height about a first axis and/or a second axis in order to achieve an optimum stacking pattern for the respective portions. As claimed in the invention or in a preferred manner, the rotational speed of the blade, the position of the blade in relation to the product and/or the position of the stacking table are now modified in dependence on the data determined. For example, it can be advantageous to reduce the rotational speed in one section of the food slab which chiefly consists of softer structures. In addition, it can be advantageous, depending on the structure of the product, to modify the site of impact and/or the ratio between pulling and pressing during cutting. In the case of soft products, the blade ought preferably to carry out chiefly a pulling and less a pressing movement. As the inner and/or outer structure also influences the stacking location of the respective product slice, it is also provided as claimed in the invention or in a preferred manner to modify the position of the table in its height and/or in its angle of inclination in dependence on the respective inner and/or outer structure of the food slab.

### LIST OF REFERENCES

1 Food slab

2 Food slice

3 Scales

4 Irradiation scanner

4.1 Sender, receiver

4.2 Receiver, sender

5 Conveying means

6 Device

7 Slicing device, slicer

8 Portioning belt

9 Start region of the food slab 1

10 End region of the food slab 1

11 Muscle in the meat

12 Fat proportion of the meat

13 First part piece of the food slab, first ham

14 Second part piece of the food slab, second ham

15 Boundary surface between first and second part piece 13, 14

16 Incomplete portion

17 Conveying direction

18 Scan slice

19 Foreign body

20 Hole in the cheese

21 Cutting blade

22 Support for the food slab

23 Stacking unit, stacking table

24 Double arrow, height adjustment of the stacking unit

25 Double arrow, rotation of the stacking unit about a first axis

26 Double arrow, rotation of the stacking unit about a second axis

a Data dots along the width of the food slab

A Grade A

B Grade B

b Data dots along the length of the food slab

Br Width of the food slab

Br′ Width of the scan region

H Height of the food slab

L Evaluatable length of the food slab

L′ Part length of reduced quality

l Length of a portion

1-n Number of portions per food slab

x Longitudinal coordinate of the food slab

What is claimed is:

1. A method for creating food portions using a slicing device (7), with each food portion having at least one food slice (2), said method comprising the steps of:
slicing the at least one food slice off a slab of food (1) using the slicing device (7)
determining data on the inner and/or outer structure of the food slab from the food slab before the respective food portion is sliced using an irradiation scanner (4), wherein the determined data is acquired in a data matrix, the data matrix is evaluated and the evaluation is used to control the slicing operation and/or to classify the sliced food slices, wherein the data matrix includes image dots, which are gray scale values.

2. The method as claimed in claim 1, wherein the data matrix is a two-dimensional or three-dimensional representation of the spatial data of the food slab.

3. The method as claimed in claim 1, wherein the irradiation scanner (4) determines data from n scan slices, which are arranged one behind the other along the longitudinal axis (x) of the food slab and which are assembled to form the data matrix.

4. The method as claimed in claim 3, wherein a plurality of measured values are determined per scan slice, preferably over the entire width (Br) of the food slab.

5. The method as claimed in claim 1, wherein the evaluation of the data matrix is effected using image recognition software.

6. The method as claimed in claim 1, wherein the evaluation is effected by way of reference data.

7. The method as claimed in claim 1, wherein the data supplies information on the development of at least one muscle (11′-11′″) in the food and the information is used to slice the food slab and/or to classify the food slices into grades (A, B).

8. The method as claimed in claim 1, wherein the food slab (1) includes several part pieces (13, 14) which adjoin along a boundary surface (15), wherein the data matrix supplies information on the development of the boundary surface (15) and the information is used to slice the food slab and/or to classify the food slices into grades (A, B).

9. The method as claimed claim 1, wherein the evaluatable length (L) is determined by way of the determined data.

10. The method as claimed in claim 9, wherein the evaluatable length is sliced into n portions which in each case have at least the required minimum weight, wherein the last portion is supplemented by food slices from the next food slab and the slicing device knows, by way of the determined data, which proportion by weight is missing and/or how many slices are missing from said portion and controls the slicing operation accordingly.

11. The method as claimed in claim 9, wherein by way of the determined data, the evaluatable length (L) of a food slab is divided into n portions, wherein each portion has at least the required minimum weight,

12. The method as claimed in claim 1, wherein the local height of the food slab is determined by way of the data matrix.

13. The method as claimed in claim 1, wherein the data matrix has local temperature data and/or local data concerning the salt content.

14. The method as claimed in claim 1, wherein the determined data is used to control the cutting speed and/or to control the position of the cutting blade.

15. The method as claimed in claim 1, wherein the determined data is used to control the portion forming parameters.
